(19) United States
(12) Patent Application Publication
(10) Pub. No.: US 2011/0208534 A1
(43) Pub. Date: Aug. 25, 2011

(54) REAL-TIME DELIVERY OF MEDICAL TEST DATA TO PORTABLE COMMUNICATIONS DEVICES

(76) Inventors: Lance A. Liotta, Bethesda, MD (US); Tyson Liotta, Rockville, MD (US)

(21) Appl. No.: 13/026,346

(22) Filed: Feb. 14, 2011

Related U.S. Application Data
(62) Division of application No. 10/130,402, filed on Oct. 17, 2002.

(51) Int. Cl. G06Q 50/00; G06Q 10/00

(52) U.S. Cl. 705/2

(57) ABSTRACT

The present invention relates to a system and method for real-time delivery of medical tests and related data from laboratories or similar sources to portable communication devices such as mobile phones, text-enabled pagers and web-enabled personal digital assistance (PDA's) and other WAP devices. The subject system enables physicians to access test results remotely as soon as they become available. Also, the system allows the physician to develop an electronic prescription and submit the electronic prescription to a pharmacy using the portable communications device.

### CROSS-REFERENCE TO RELATED APPLICATION

This application is a divisional application of application Ser. No. 10/130,402, filed Oct. 17, 2002, which claims the benefit of U.S. Provisional Application No. 60/165,500 filed Nov. 15, 1999.

### BACKGROUND OF THE INVENTION

The present invention relates to a system and method for real-time delivery of medical tests and related data from laboratories or similar sources to portable communication devices such as mobile phones, text-enabled pagers and web-enabled personal digital assistance (PDA's). The subject system enables physicians to access test results remotely as soon as they become available. The subject system enables the physician to develop a prescription on a wireless device, such as a web enabled telephone, and submit the prescription electronically. The subject system exists as an interactive hub on the internet/world-wide-web (web) that exchanges information with portable devices. A special advantage is that the portable wireless devices do not need to be individually programmed or contain dedicated software—only a web browser is required. Also, the physician need not be within range of a particular computer installation. Instead, the system is operative anywhere wired and/or wireless internet access is available.

Healthcare is the largest single sector of the U.S. economy, consuming approximately $1 trillion annually, or 14% of the country's gross domestic product. In the U.S., the rise of managed care has forced healthcare facilities, physicians, and patients to focus on reducing the cost of care while maintaining the quality of care. In response, healthcare providers have been consolidating, and are turning towards information technology to reduce costs; and patients are using the Internet as a free and convenient source of health information.

Communications networks, such as the internet new mobile computing platforms, hold the potential to make the healthcare system more efficient by creating virtual relationships—bringing together physicians, payers, suppliers, and patients. The health and medical market is already one of the fastest growing areas of interest on the internet, making it the second largest vertical category behind financial services. A number of healthcare-focused portals such as drkoop.com and Healtheon provide content, commerce, and community. In addition, several online pharmacies such as PlanetRx and Drugstore.com provide is online access to prescription medicines.

Mobile devices such as cellular phones, pagers, and palm computers have been used by physicians for years, providing them the benefits of mobility while traveling between office, hospital, and clinic. Physicians view these devices as indispensable to their work, and are familiar with the associated air time fees.

Current means of accessing lab results in the physician office environment are grossly inefficient, requiring physicians and labs to administer large amounts of faxed or couriered paper documents. Physicians phone the lab to retrieve test results and/or the lab sends a report by courier or fax to the physician's office. This usually happens the day after patient specimens are sent to the laboratory. This process imposes administrative burdens on both the physician's office and the lab as phone calls and faxes are exchanged. The physician, who is often mobile, must be contacted with the results in order to prescribe a treatment regimen. Meanwhile, the patient is anxiously awaiting the results with no access to information except by making a phone call to the physician's office.

With particular reference to mobile telephones, no prior systems are known to exist for receiving and transmitting medical information and/or transaction data. Mobile telephones have a limited display screen size and wireless data is transmitted to and from mobile telephones at rates that are slower than other wireless/wired devices. The limited screen size and buffer size require an elegant user interface for conveniently and effectively displaying all data and receiving input from a physician.

In light of the foregoing specifically noted deficiencies and others associated with conventional delivery of medical test data to physicians, a need has been identified for a system that increases the speed-accuracy- and security of medical test data delivery while providing better overall results.

### SUMMARY OF THE INVENTION

In accordance with a first aspect of the present invention, a method for delivery and use of medical test data includes receiving medical test data related to at least one patient. The medical test data are generated by at least one medical laboratory in response at least one order of a physician. The medical test data are stored on a medical data server. The physician is notified by way of a portable communications device controlled by the physician that the medical test data are available on said medical data server. The medical test data are sent to the portable communications device controlled by said physician. Preferably, the portable communications device is a web-enabled mobile telephone.

One advantage of the present invention resides in the provision of a novel and non-obvious system for real time delivery of medical test data to portable communications devices.

Another advantage of the present invention results from the provision of a novel and non-obvious system for real-time delivery of medical test data to a mobile telephone, wherein the phone can be used simultaneously for transmission/receipt of voice data.

Another advantage of the present invention is found in the provision of a system for real-time delivery of medical test data to portable communications devices, wherein a physician awaiting medical test data is notified as soon as the data are available.

A further advantage of the present invention is the provision of a system for real-time delivery of medical test data to portable communications devices, wherein a mobile physician is able to receive the data, interpret the data, and prescribe a treatment regiment without returning to his/her office or other base location.

Still another advantage of the present invention resides in the provision of a system for real-time delivery of medical test data to portable communications devices, wherein patients receive test results and associated information in a more timely and secure manner from physicians.

Yet another advantage of the present invention resides in the provision of a system for real-time delivery of medical test data to portable communications devices wherein the need to fax and/or courier test result documents is eliminated.

A further advantage of the present invention resides in the provision of a system for real-time delivery of medical test data, wherein a secure and convenient web-based interface is provided for physician access to the system.

Still other benefits and advantages of the present invention will become apparent to those of ordinary skill in the art to which the invention pertains upon reading and understanding this specification.

### BRIEF DESCRIPTION OF THE DRAWINGS

The invention comprises various components and arrangements of components, and comprises various steps and arrangements of steps, preferred embodiments of which are illustrated in the accompanying drawings that form a part hereof and wherein:

FIG. 1 is a simplified diagrammatic illustration of a system for real-time delivery of medical test data formed in accordance with the present invention;

FIG. 2 is a more detailed diagrammatic illustration of the system of FIG. 1;

FIG. 3 illustrates one type of portable is communications device to which medical test data is delivered in accordance with the present invention;

FIG. 4 illustrates a web-page physician interface to a medical data server that forms a part of a the system for real-time delivery of medical test data provided in accordance with the present invention;

FIG. 5 is a flow-chart that discloses a method for real-time delivery of medical test data in accordance with the present invention;

FIG. 6 is a flow chart that discloses a method for automatically obtaining medical test data from a laboratory information server and storing same on a medical data server in accordance with the present invention;

FIG. 7 diagrammatically discloses a method by which lab results and other medical test data are stored on a medical data server in accordance with the present invention;

FIG. 8 diagrammatically illustrates operation of a software agent in accordance with the present invention for purposes of obtaining information from a laboratory information system (LIS) and storing same on a medical data server;

FIG. 9 is a flow chart that discloses a method by which a physician uses a communications device to receive medical test data from the medical data server;

FIGS. 10A and 10B are respective first and second examples of a method for presenting medical test data to a physician by way of a portable or fixed communications device;

FIG. 11 is an example of a method by which the various test results available for a particular patient are set forth for a physician on his/her communications device;

FIG. 12 is an example of medical test data displayed to a physician on his/her communications device for a particular patient and test;

FIG. 13 is a flow chart that discloses a method by which a physician uses his/her communications device to prescribe pharmacological treatment to a patient using his/her communications device;

FIGS. 14-25 illustrate real-time delivery of medical test data to a portable telephone in accordance with the present invention and a physician's use of a portable telephone to write and send prescription data to a pharmacy in accordance with the present invention; and,

FIGS. 26-33 together define a flow chart that discloses the methods illustrated in FIGS. 14-31.

### DETAILED DESCRIPTION OF PREFERRED EMBODIMENTS

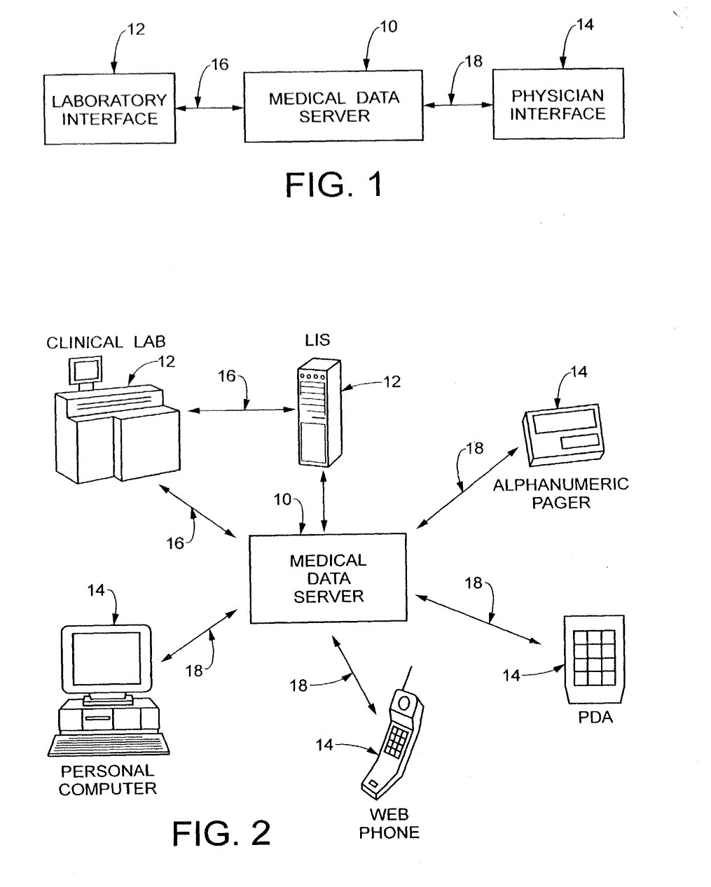

Referring now to the drawings, wherein the showings are for the purpose of illustrating preferred embodiments of the invention only and not limiting the invention in any way, FIGS. 1 and 2 illustrate a system for real-time delivery of medical test data to portable communications devices in accordance with the present invention. As illustrated in FIG. 1, the system comprises a medical data server computer 10, provided by any suitable computer, that receives medical test data such as lab reports and the like from a laboratory interface 12 and provides same to a physician interface 14. Data flow takes place using any suitable wired or wireless computer network(s). In a preferred embodiment, a hard-wired computer network 16, such as a dial-up network, an intranet, an extranet, the internet, etc., is utilized to move data between the laboratory interface 12 (i.e., the source of the medical test data) and the medical data server 10. In this preferred embodiment, it is most preferred that a wireless network 18, based upon cellular, PCS, or any other suitable wireless technology, be used to delivery medical test data from the medical data server 10 is to the physician interface 14, which may be provided by any portable or fixed communications device.

Referring now to FIG. 2, the medical data server 10 is connected by the network 16 to one or medical testing data providers via laboratory interfaces 12 such as a clinical lab computer and a laboratory information server or system LIS. The physician interface 14 for one or more physicians to access and receive data from the medical data server 10 is provided by suitable portable wireless communications devices such as alphanumeric pagers, personal digital assistants (PDA's), web-enabled portable telephones, or other WAP (Wireless Application Protocol) devices and the like. A wired, fixed physician interface is also preferably provided by way of a personal computer or other fixed communications device. In such case, the network connection 18 could be provided by a dial-up or internet connection.

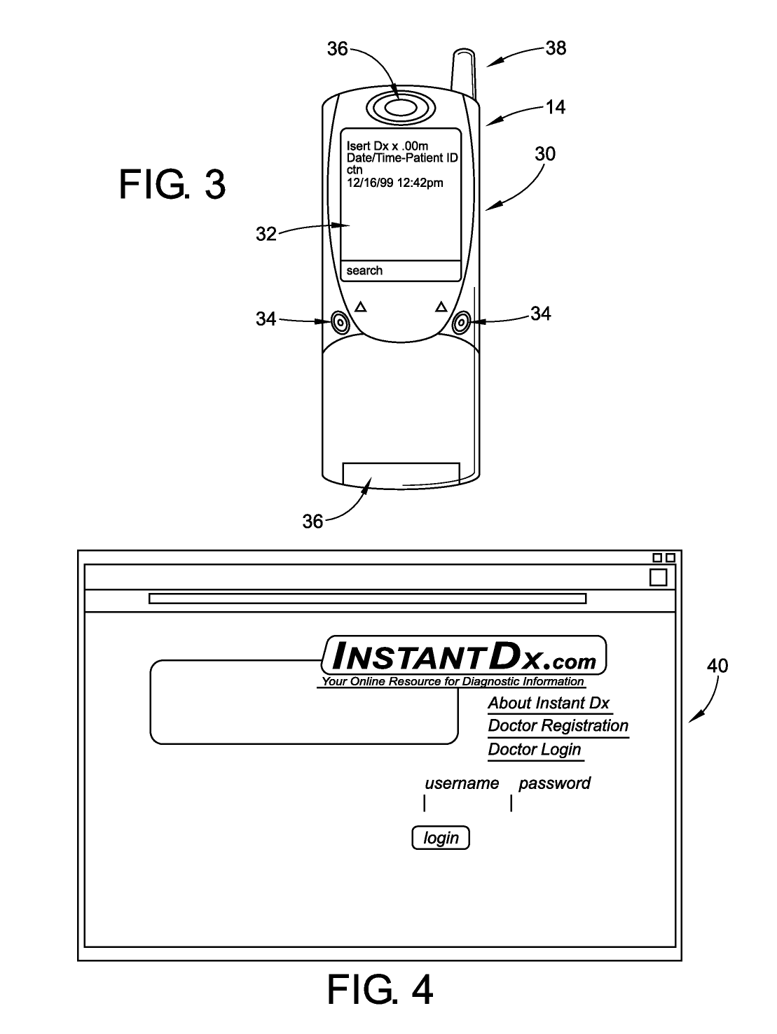

FIG. 3 illustrates an example of a suitable wireless physician interface 14 comprising a wireless web-enabled or other telephone 30 including a visual display 32 by which the physician receives text and other visual output from the device 30. The device 30 also comprises input means such as buttons 34 or the like, a microphone 36 for receipt of voice data/commands, a speaker for output of audible data, and an antenna for wireless connection to the medical data server 10.

FIG. 4 illustrates an example of a suitable physician interface 14 as provided by a personal computer. The illustrated web page 40 is presented to the physician by way of a monitor, screen, or other visual output device of the personal computer. The physician interacts with the web page using pointing devices, a keyboard, etc. and sends/receives data therethrough as is generally well known in the computing arts.

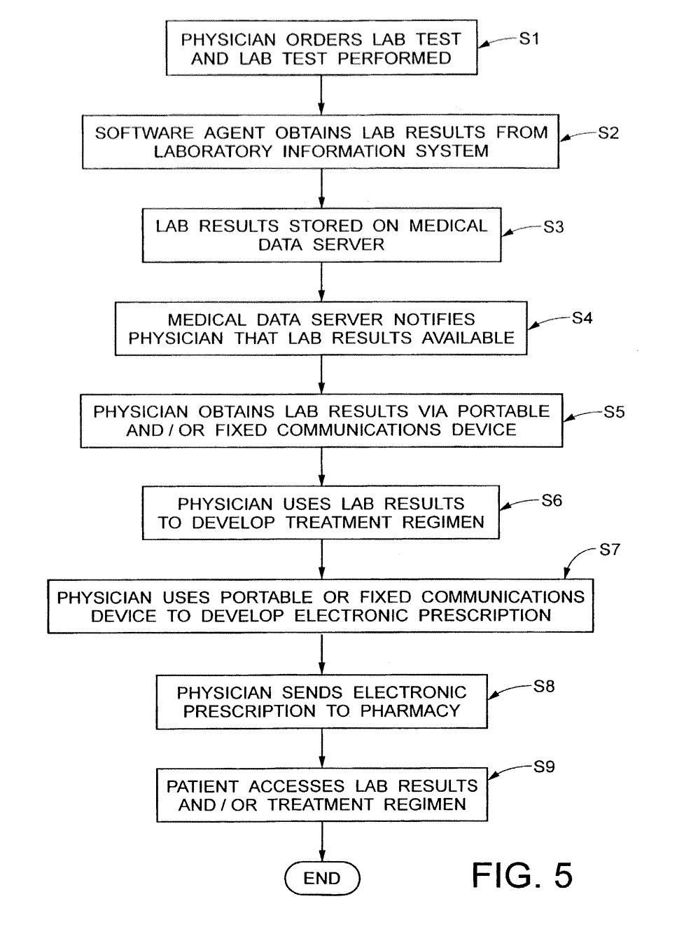

Referring now to FIG. 5, a method for real-time delivery of medical test data to portable communications devices in accordance with the present invention is disclosed. The method comprises a step S1 including the physician ordering a lab test and performance of the lab test in a conventional manner. In a step S2, a software agent, installed on the laboratory information system LIS or other laboratory computer, obtains the lab results therefrom. In a step S3, the software agent sends the retrieved lab results, by way of the network 16, to the medical data server 10 where the data are stored.

Once the medical data server 10 has stored the newly obtained lab results or other medical test data, it performs a step S4 of notifying the physician that ordered the test(s) that the lab results are available. The step S4 is preferably carried out by sending a signal to a portable communications device carried by the physician such as a pager, cellular/PCS telephone, PDA, or the like.

In a step S5, the physician that ordered the test(s) obtains the lab results using one of the portable and/or fixed communications devices 18 by way of the network 18. Specifically, using one of the physician interface communications devices 14, the physician access the medical data server 10 which, in turn, supplies the lab results or other medical test data to the physician interface device 14.

The step S6 comprises the physician using the lab results obtained from the medical data server 10 to develop a treatment regimen which may include, for example, prescription of a pharmacological treatment.

In a step S7, the physician uses his/her portable or fixed communications device 14 to develop an electronic prescription, if necessary. The physician then uses the device 14 to send the electronic prescription to a pharmacy. This is accomplished by alternative means. In one example, the communications device 14 sends the is electronic prescription to the medical data server 10 by way of the network 18. The medical data server 10 then connects to a computer at the pharmacy using a modem or any other suitable data network for the purpose of sending the electronic prescription to the pharmacy. In another embodiment, the physician uses his/her communications device 14 to connect directly with a pharmacy. For example, if the physician is using a communications device 14 that includes telephone capabilities, the physician can simply contact the pharmacist and provide an oral prescription or can transmit the electronic prescription data directly to a computer located at the pharmacy without sending the data through the medical data server 10.

In an optional step S9, a patient can access his/her own lab results and other medical test data, and review the physician's treatment regimen, by using a portable or fixed communications device 14 and connecting to the medical data server via network 18. In this manner, a patient can have instant and convenient access to his/her lab results and treatment regimen. Also, the physician and physician's staff are saved the administrative burden of retrieving this information for the patient.

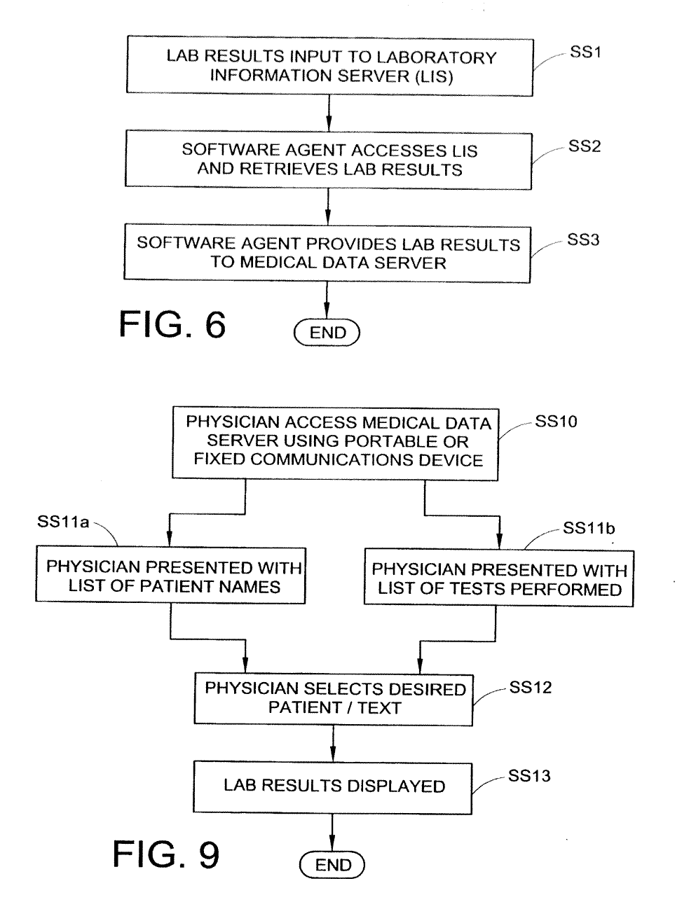

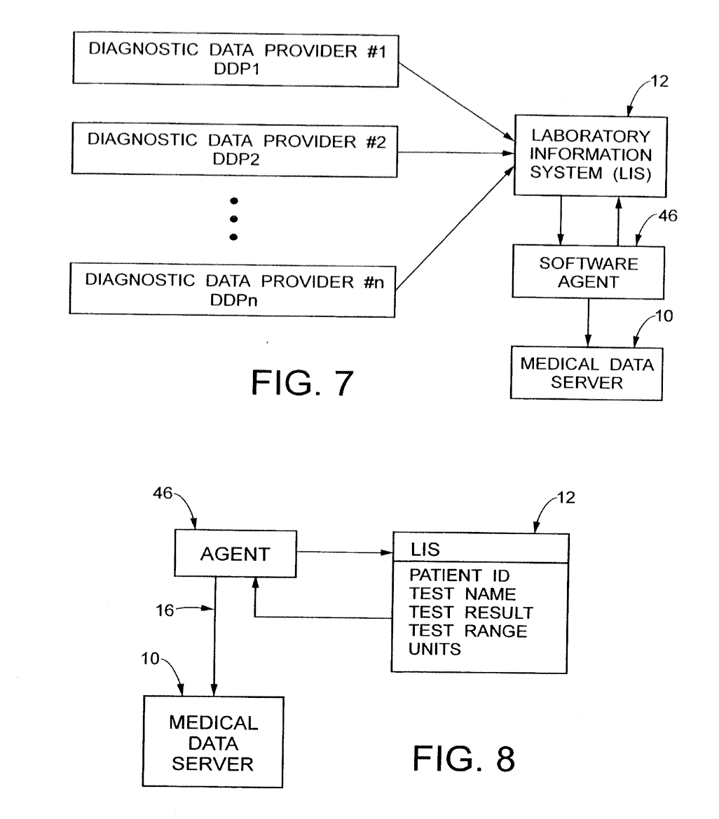

FIG. 6 discloses substeps related to steps S1-S3 of FIG. 5. In a substep SS1, the lab results or other medical test data are input to the laboratories computer system, referred to herein as a laboratory information system or server LIS. As shown in FIG. 7, this can be an automatic step wherein one or more diagnostic data providers DDP1,DDP2, DDPn are connected to the laboratory information system LIS and supply data thereto. In a step SS2, a software program, referred to herein as a software agent 46, accesses the laboratory information server LIS and retrieves the desired lab results and associated data. This is shown diagrammatically in FIGS. 7 and 8, wherein the agent 46 obtains from the laboratory information system is LIS information such as the patient ID or name, test name, test result, test range, and units or measurement. The agent, of course, is programmed according to the specific laboratory information system LIS and its actions vary depending upon the data structures employed in the laboratory information system LIS. Finally, in a substep SS3, the software agent sends the retrieved lab results and/or other medical test data to the medical data server 10 by way of the network 16. Those of ordinary skill in the art will recognize that multiple software agents are used on multiple laboratory information servers LIS and are each sending data to the medical data server 10 for use by multiple physicians and in connection with treatment of multiple patients.

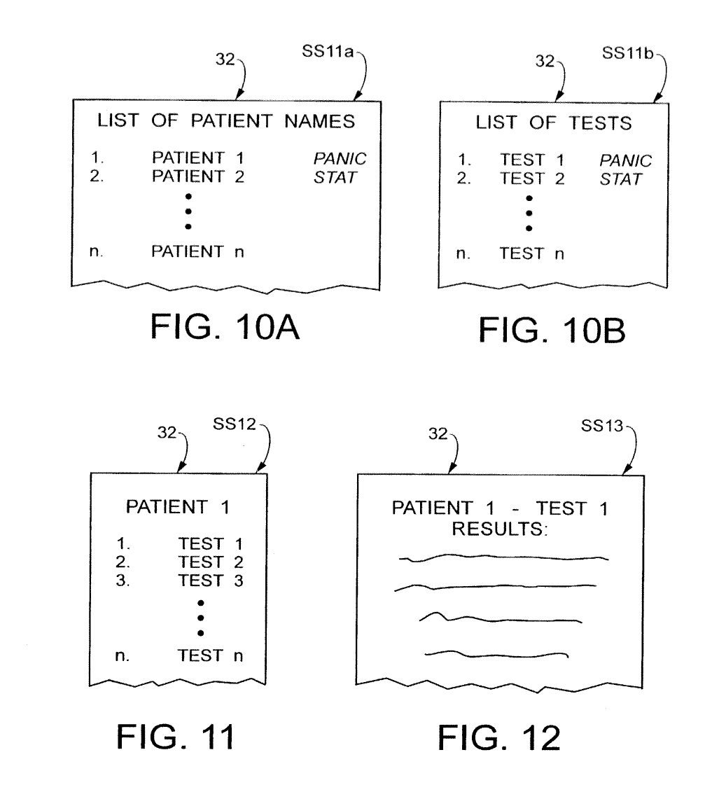

FIGS. 9-12 illustrate and discloses substeps and details related to steps S5 and S6 noted above, namely the steps related to the process by which a physician received lab results and/or other medical test data using a portable or fixed communications device. FIGS. 10A-12 diagrammatically illustrated a visual output display 32 of the portable communications device 30 noted above. In a substep SS10, the physician uses the device 30 to connect with and access the medical data server 10. In substeps SS11a, SS11b, the physicians, depending upon his/her preference, is presented with a list of patient names or a list of tests performed upon the physician's orders (see FIGS. 10A, 10B, respectively). According to substep SS11a, and patient for whom a “panic” or “stat” lab result is indicated, that patient's name is listed before all other patients in the list displayed to the physician. Likewise, according to the substep SS11b, all “panic” and “stat” test results are displayed first to the physician.

Using the input buttons, a stylus, or other conventional input means associated with portable communications devices (or a mouse or keyboard if a PC is being used), in a substep SS12, the physician selects the patient or test. As shown in FIG. 11, for each patient selected, all tests associated with that patient are then displayed to the physician. The physician then selects the particular test in which he/she is interested and, in a substep SS13, these lab results are displayed to the physician as shown in FIG. 12.

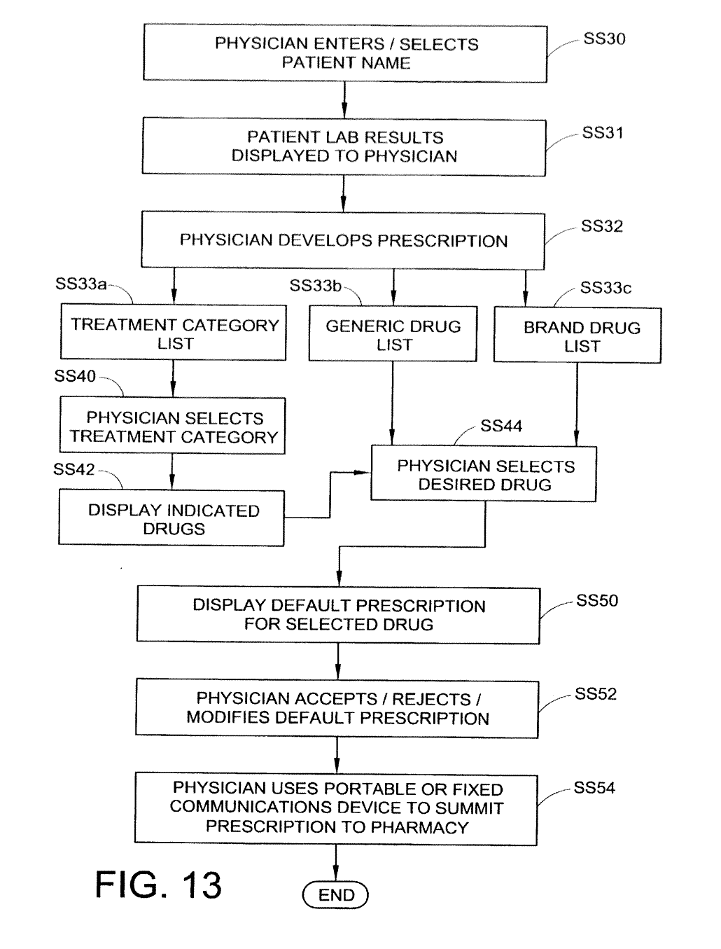

Referring now to FIG. 13, the details of the steps S7 and S8 are disclosed, namely the process by which a physician develops and sends to a pharmacy a prescription for a particular patient. In a substep SS30, the physician either enters or selects from a list the patient's name. Lab results associated with the subject patient are displayed to the physician as shown, e.g., in FIGS. 11 and 12. In a substep SS32, the physician develops a prescription for that patient using one of several procedures. In a substep SS33a, the physician is presented with a list of treatment categories including, e.g., infectious, cardiac, asthma, allergy, cough, etc. In a substep SS40, the physician selects one of the displayed treatment categories and in a substep SS42, a list of commonly indicated drugs for the selected category is displayed to the physician. Then in the substep SS44, the physician selects the desired branded or generic drug. In an alternative embodiment, the physician is presented with a list or generic (substep SS33b) or branded drugs (substep SS33c) and, in a substep SS44, the physician selects a desired drug for the patient being treated.

In any case, the process continues with substep SS50 that includes displaying a predefined default prescription for the selected drug to the physician. In a substep SS52, the physician either accepts the default prescription or modifies same. Finally, in a substep SS54, tile physician uses the portable communications device 14 to send the electronic prescription to the pharmacy desired by is the patient as specified in advance.

In a most preferred embodiment, the medical data server 10 and/or the portable device 14 remember(s) previous preferences of each physician (this information is preferably stored in the server 10 to minimize memory usage in the portable device 14). Thus, for example, a physician's preferences concerning output format of test results or pharmaceuticals prescribed in connection with particular test results are stored at the server 10 or in the portable device 14. These stored preferences are presented to the physician at the portable device 14 or other physician interface as a default to minimize required input from the physician. For example, if a physician typically specifies “dispense as written” (DAW) for prescriptions, this information is stored and presented as a default for all prescriptions. Further, it is also preferred that the medical data server 10 and/or the device 14 aid in patient care and compliance by notifying the physician of potential pharmaceutical conflicts or contraindications. In one embodiment, the medical data server 10 receives information from pharmacies concerning whether a patient has filled or refilled prescriptions as specified. If the patient has not complied, the physician is notified by way of the portable device 14. Of course, the medical data server 10 can interface with or include known expert systems to aid in diagnosis, treatment, and patient compliance. This information is also transmitted to the wireless device 14 upon request or automatically. For example, in the event a physician attempts to prescribe a pharmaceutical or dosage of same that is deemed inappropriate by the expert system, the physician is notified and is required to confirm his/her actions. In another example, when a physician prescribes a pharmaceutical that requires the patient submit to additional lab testing, the medical data server 10 sends a message to the portable device 14 periodically, on a select date or otherwise to remind the physician of same.

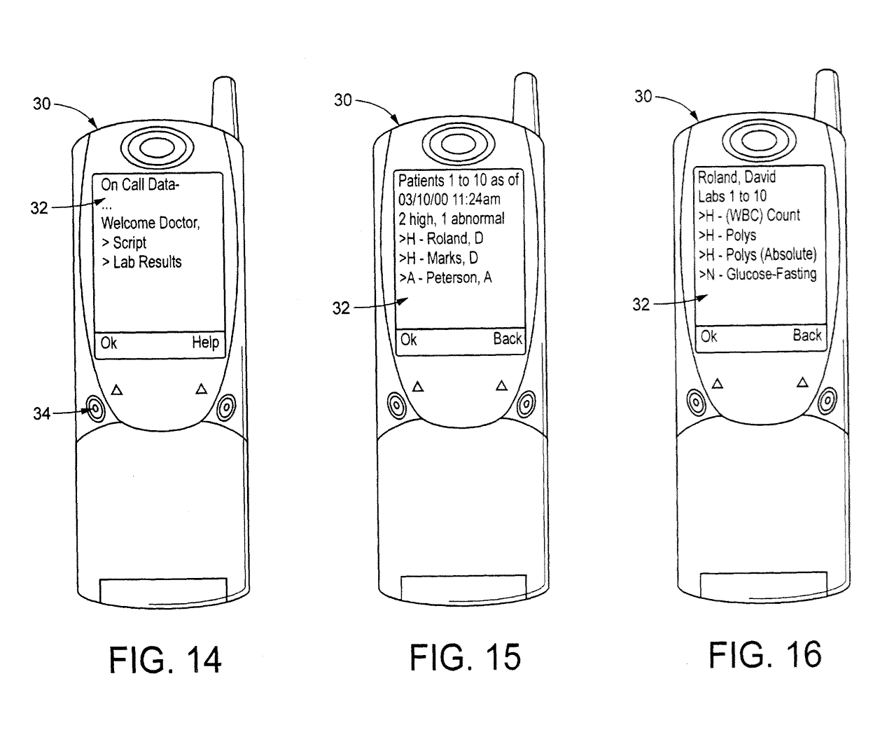

Referring now to FIGS. 14-23, use of the mobile web-enabled phone 30 to provide real-time medical test data to a physician is illustrated. The transaction is carried out by sending wireless data between the server 10 to the mobile device 30. At the mobile device, the physician preferably receives data by way of the visual output display 32, and preferably inputs data to the mobile device 30 by way of the one or more input buttons 34.

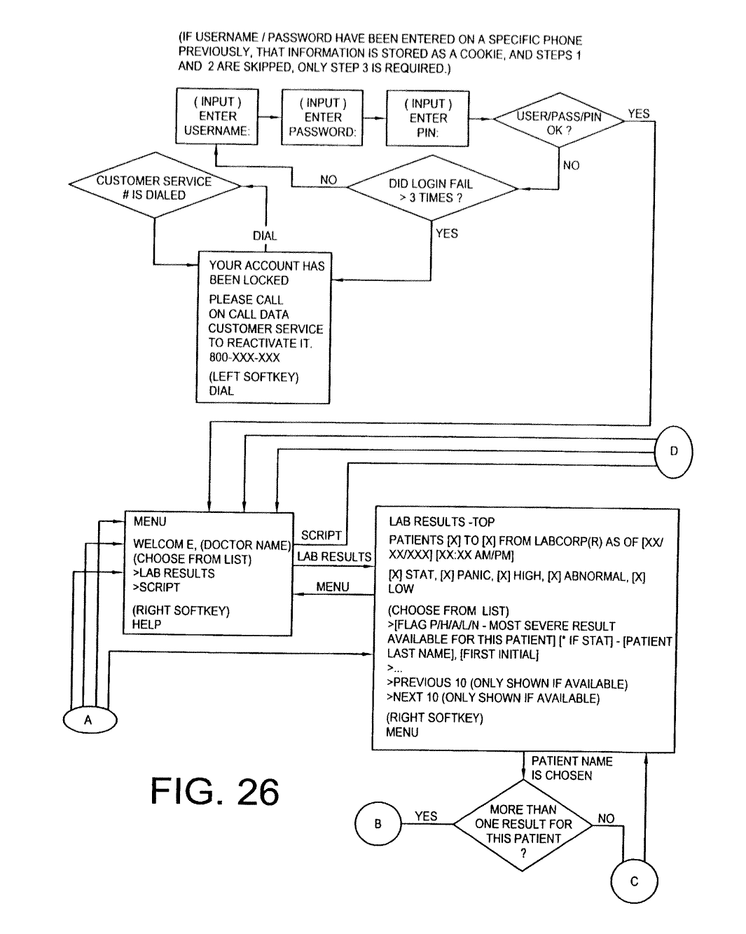

FIG. 14 illustrates a welcome display from which the physician chooses to write a prescription or receive lab results. In the present example, the physician chooses to review lab results. As shown in FIG. 15, the physician is presented with an overview of lab results for his/her patients. As noted above, patients are listed in order of lab result severity with quality designations such as “H” for high results, “L” for low results, “A” for abnormal results, “N” for normal, etc. The physician is able to use the input buttons 34 or other input means to scroll through the list and select a patient from the list (see also FIG. 26).

As shown in FIG. 16, the physician has selected patient “Roland, David” and is presented with a list of lab results for the patient, again with the quality designation for each test an in order of severity. Here, the physician selects the first listed result “H-(WBC) Count.”

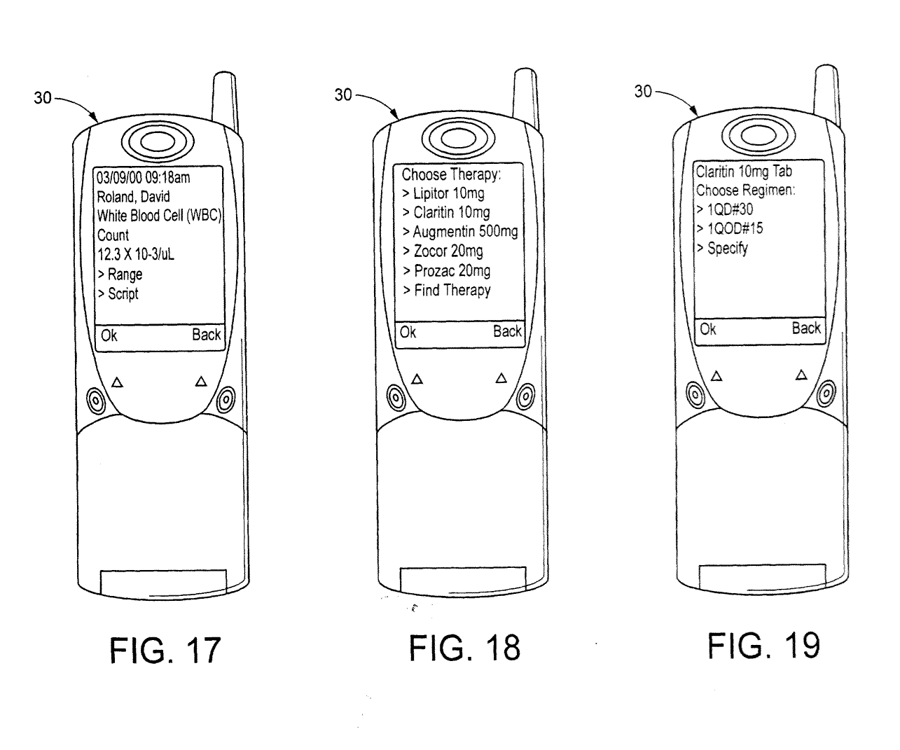

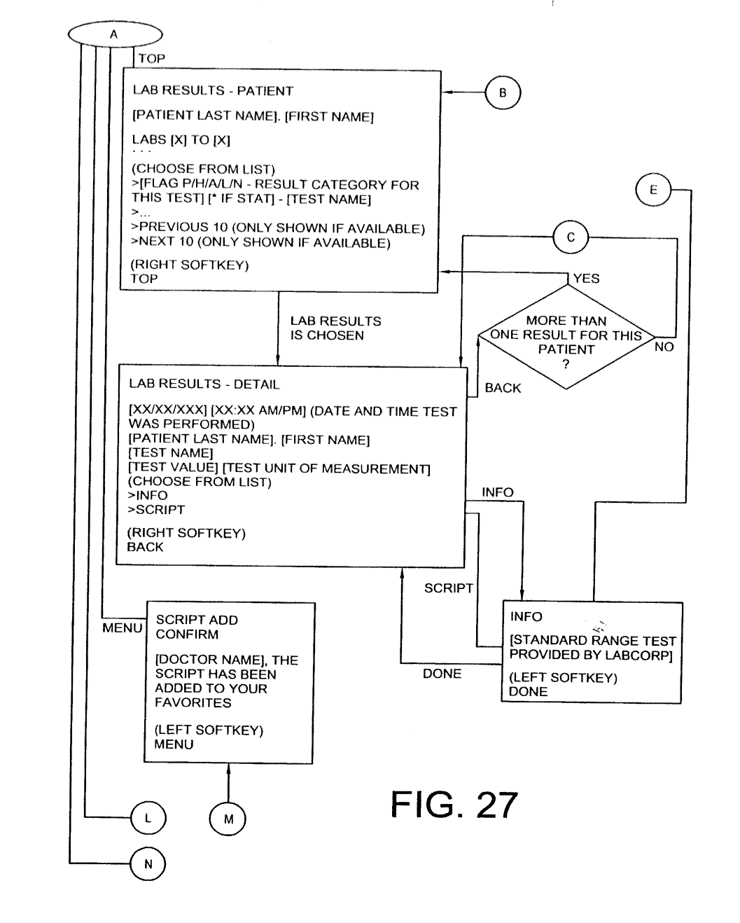

Turning to FIG. 17, the select lab data is displayed. This includes the date/time of the test, the patient's name, the name of the test performed, and the exact test value. The physician may also select “Range” to receive information that defines a standard or normal range for the displayed test. Also, at this stage, the physician may select “Script” to write and submit to a pharmacy a prescription for the patient as described below (see also is FIG. 27).

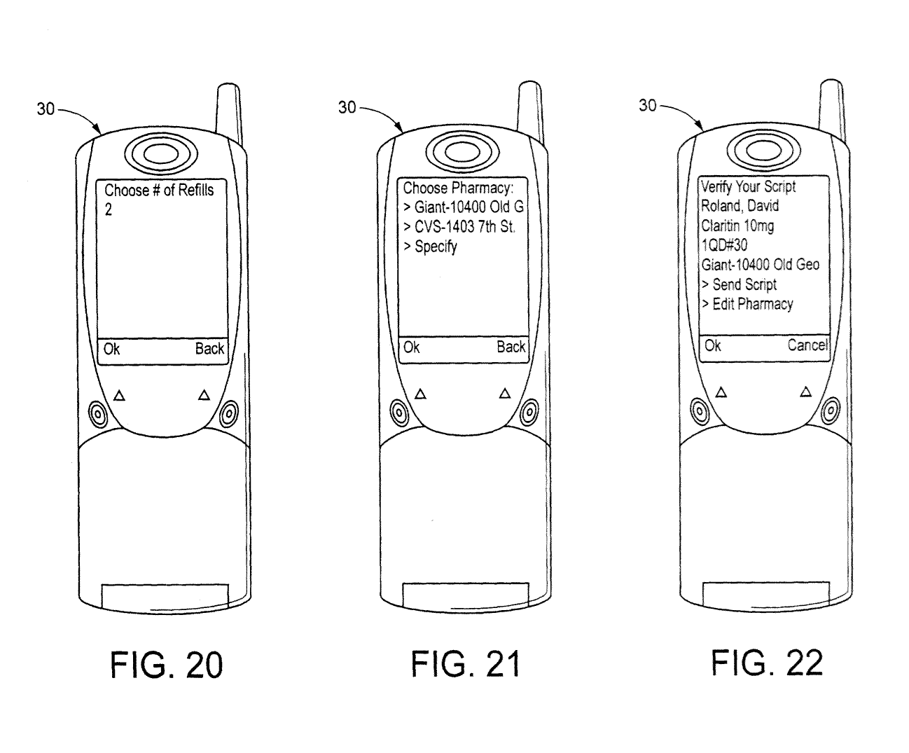

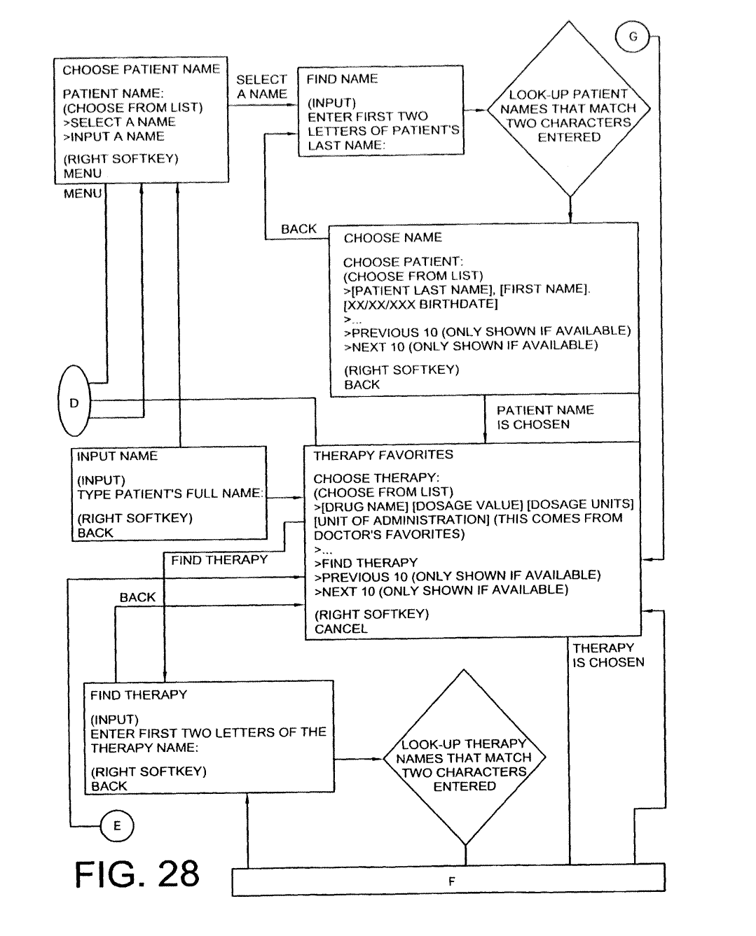

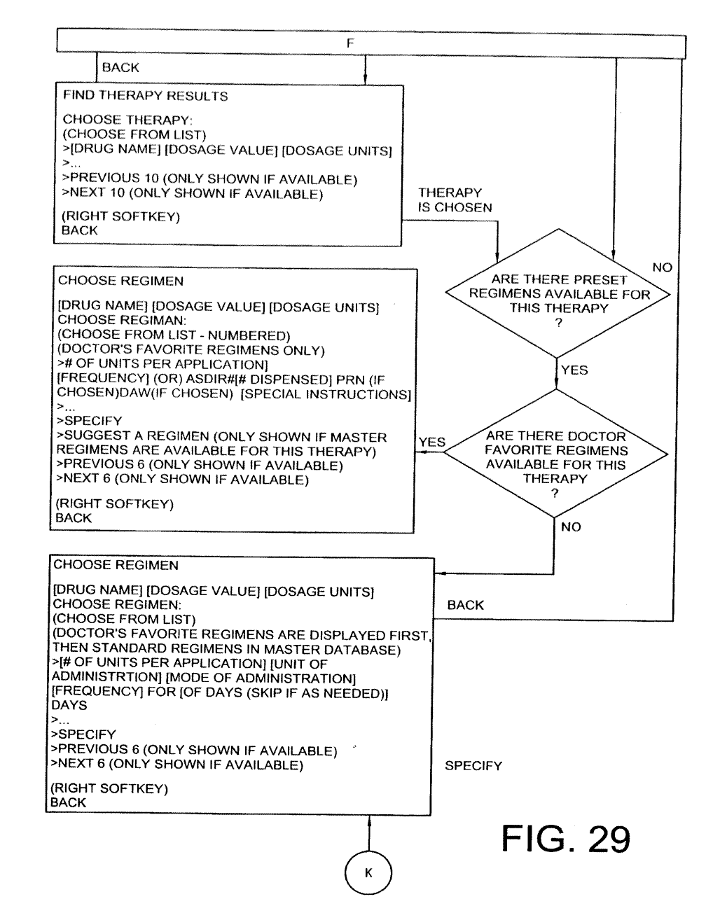

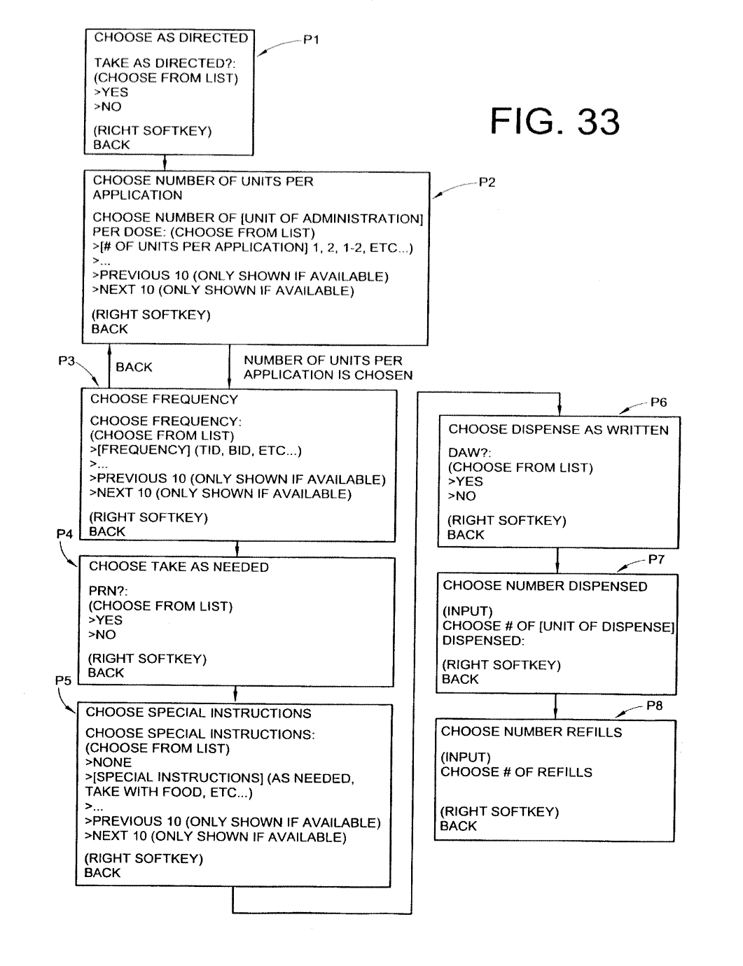

FIG. 18 illustrates the result when the physician selects the “Script” option. The physician is presented with a list of favorite (most commonly prescribed) therapies (drugs) for conditions related to the lab results reviewed by the physician immediately prior to this stage. The physician may select a therapy from the list or may select “Find Therapy” to search for others. Here, the physician selects “Claritin 10 mg” and is presented with the regimen data shown in FIG. 19. The physician selects or inputs the desired regimen at this stage and, as shown in FIG. 20, is prompted to input the number of refills. As illustrated in FIG. 33, it is most preferred that the physician be presented with multiple prompts on the display 32, such as those shown at P1-P8, and that the physician respond to each prompt P1-P8 as desired to develop the regimen using the input buttons 34 or other input means (see also FIGS. 28-29).

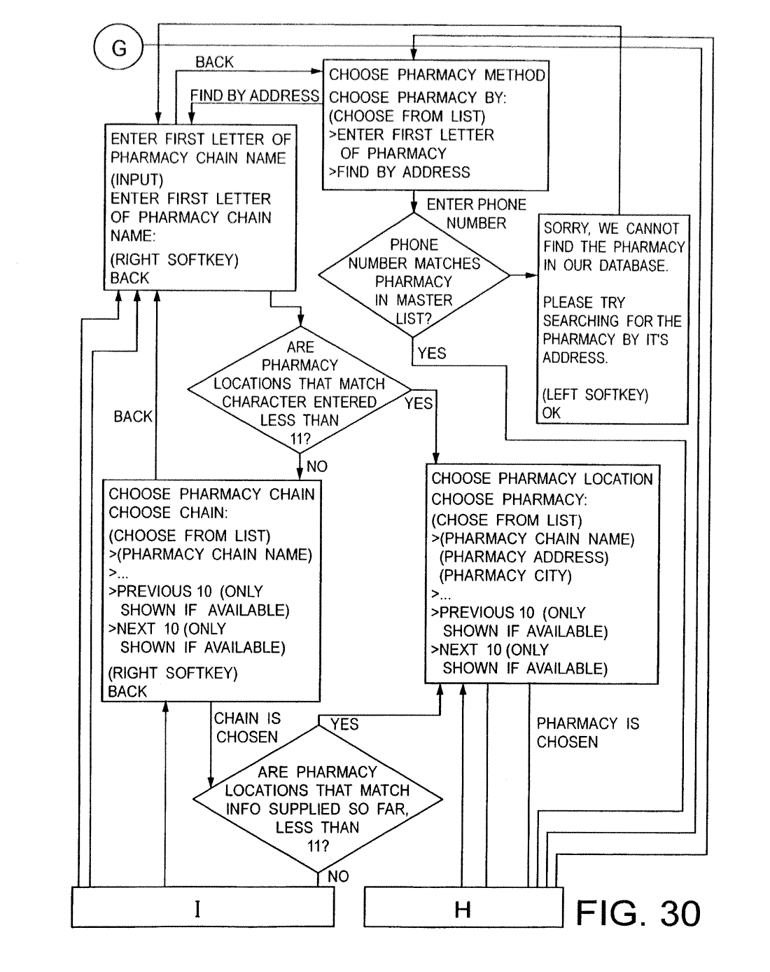

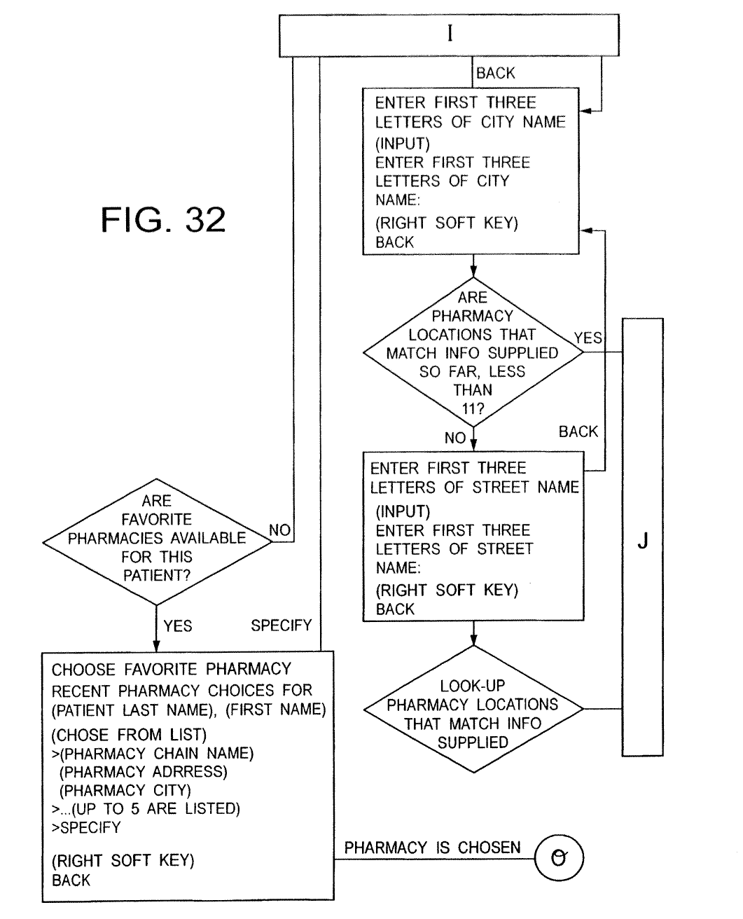

To submit the prescription to a pharmacy, the physician is presented with the data shown in FIG. 21. If the physician has written prescriptions for the subject patient previously, the previously used pharmacy or pharmacies are displayed and may be selected (see also FIG. 32). Otherwise, the physician inputs the desired pharmacy by phone number, address, or the physician may select a pharmacy from a predefined list of local pharmacies (see also FIG. 30).

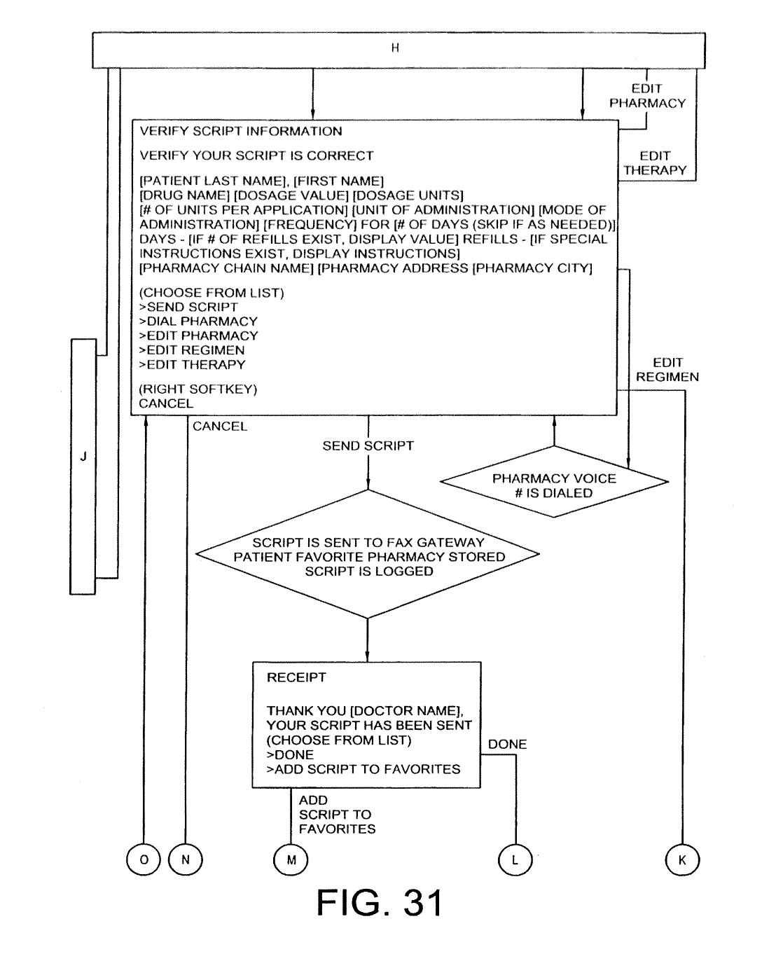

As shown in FIG. 22, the written prescription and selected pharmacy are displayed to the physician and he/she is required to verify same. At this stage, the physician may select “Send Script” to send the prescription to the pharmacy. Alternatively, the physician can edit previously entered information. Of course, at any stage, the physician is able to use to telephone 30 to send receive voice data, and he/she may prefer to submit prescriptions in this manner (see also FIG. 31).

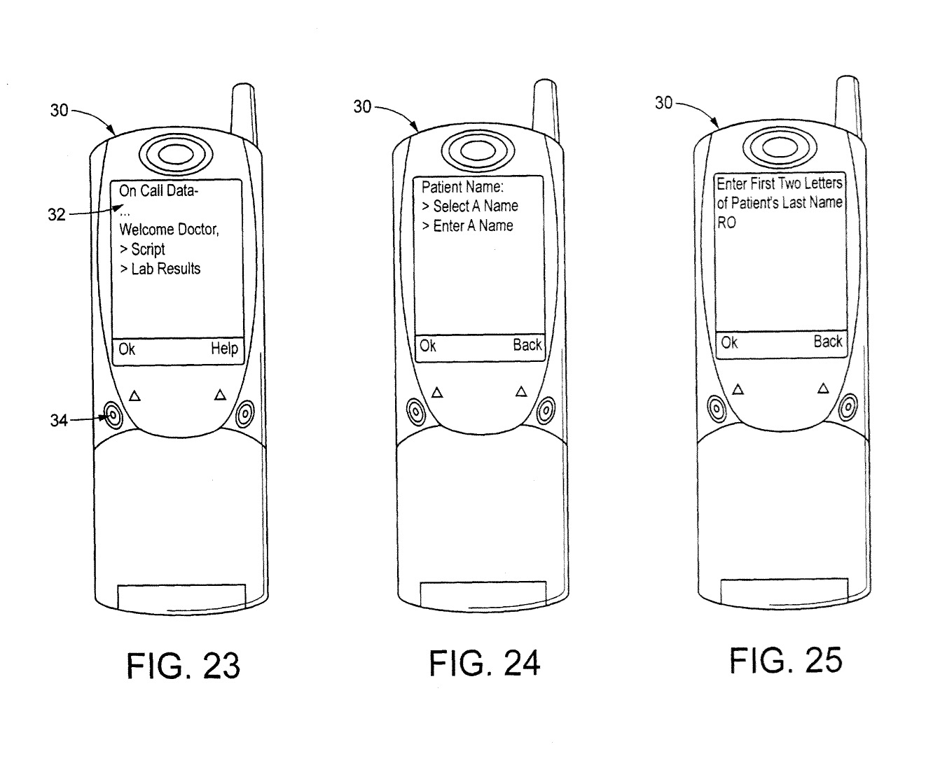

FIG. 23 again illustrates the welcome message displayed to a physician using the mobile device 30. The physician selects the option “Script” at this stage to immediately write and submit a prescription in accordance with the steps disclosed above. In such case, the physician must select from a list or enter a patient name as shown in FIG. 24. If the physician chooses to enter a name, he/she may enter only a portion thereof (FIG. 25) at which time a list of potentially matching patient names is displayed to the physician. The physician may then select the desired patient from the list. Following this, the procedure is in accordance with that described above in relation to FIGS. 18-22.

The invention has been described with reference to preferred embodiments. Modifications and alterations will occur to others upon a reading and understanding of the preceding specification. It is intended that the invention be construed as including all such modifications and alterations.

1. A method for delivery and use of medical test data comprising:
receiving medical test data related to at least one patient, said medical test data generated by at least one medical laboratory in response at least one order of a physician;
storing said medical test data on a medical data server;
notifying said physician that said medical test data are available on said medical data server; and,
sending said medical test data to a portable communications device controlled by said physician.

2. The method for delivery and use of medical test data as set forth in claim 1, wherein said steps of receiving and storing medical test data together comprise continuously receiving and storing updated medical test data on the medical data server, and wherein said step of sending said medical test data comprises wireless transmission of said medical test data to said portable communications device, said method further comprising using a web browser in said portable communications device to display said medical test data to said physician.

3. The method as set forth in claim 2, further comprising:
tracking and storing in said internet web server physician preferenced for presentation and use of said medical test data.

4. The method as set forth in claim 3, further comprising:
sending information to said portable communications device from said internet web server to provide said physician with information concerning patient care and compliance related to said medical test data.

5. The method as set forth in claim 1, further comprising, after said storing step:
receiving a request from said portable communications device to send said medical test data to said portable communications device, wherein said step of sending said medical test data to said portable communications device is carried out in response to said request.

6. The method as set forth in claim 1, wherein said steps of receiving and storing medical test data related to at least one patient comprises receiving medical test data related to a plurality of different tests and patients from a plurality of different medical laboratories in response to a plurality of different orders of said physician.

7. The method as set forth in claim 6, wherein said step of sending said medical test data to said portable communications device comprises sending medical test data related to a plurality of different tests and patients from a plurality of different medical laboratories in response to a plurality of different orders of said physician controlling said portable communications device.

8. The method as set forth in claim 7, further comprising, after said sending step:
using said portable communications device to display to said physician one of: (i) a first list comprising names of a plurality of different patients for which medical test data have been sent to said portable communications device; and, (ii) a second list comprising names of a plurality of different tests for which medical test data have been sent to said portable communications device.

9. The method as set forth in claim 8, wherein said first and second lists begin with all patient names and all tests, respectively, with which panic and stat medical test data are associated.

10. The method as set forth in claim 8, further comprising, after said step of displaying one of said first and second lists:
receiving input from said physician, through said portable communications device, that indicates a patient and a test, for which said physician desires to receive further information.

11. The method as set forth in claim 10, further comprising:
based upon said input received from said physician concerning the desired patient and test for which said physician desires to receive additional information, (i) sending to said portable communications device desired medical test data related to said desired test and desired patient; and, (ii) using said portable communications device to display said desired medical test data.

12. The method as set forth in claim 1, further comprising:
receiving input from said physician at said portable communications device related to a pharmacological treatment prescribed by said physician for said at least one patient;
generating an electronic prescription that describes said pharmacological treatment; and,
sending said electronic prescription to a pharmacy.

13. The method as set forth in claim 12, wherein said step of receiving input from said physician related to a pharmacological treatment comprises:
using said portable communications device to display to a physician a list of drugs;
receiving from said portable communications device input from said physician relating to a drug selected from said list that said physician desires to prescribe;
using said portable communications device to display to said physician a predefined default electronic prescription for said selected drug;
receiving from said portable communications device input from said physician that one of: (i) accepts said predefined default electronic prescription; and, (ii) modifies said predefined default electronic prescription; and,
sending said electronic prescription from said portable communications device to a pharmacy.
